(19) United States
(12) Patent Application Publication
(10) Pub. No.: US 2008/0154793 A1
(43) Pub. Date: Jun. 26, 2008

(54) METHOD AND SYSTEM FOR IMPROVED OUTSOURCING

(75) Inventors: Stuart McGregor, Brighton East (AU); Chris Mrakas, Oyster Bay (AU)

Correspondence Address: FULBRIGHT & JAWORSKI L.L.P, 2200 ROSS AVENUE, SUITE 2800, DALLAS, TX, 75201-2784, US

(73) Assignee: Netfusion Pty Limited, Royal Exchange (AU)

(21) Appl. No.: 11/953,411

(22) Filed: Dec. 10, 2007

(30) Foreign Application Priority Data
Dec. 11, 2006 (AU) 2006906902
Dec. 21, 2006 (AU) 2006907252

(51) Int. Cl. G06Q 40/00

(52) U.S. Cl. 705/36 R

(57) ABSTRACT

The cost savings of outsourcing may be thought of as a predictable but illiquid cash flow. The illiquid cash flow is monetized by way of securitization. A method of monetizing a cash flow asset obtainable from the difference between the costs of an in-house business component of a client and the costs of outsourcing that business component is provided. The method comprises outsourcing the business component of the client to an outsourcing vendor, and securitizing the asset.

### CROSS-REFERENCE TO RELATED APPLICATIONS

The present application claims priority from Australian Provisional Patent Application No 2006906902 and from Australian Provisional Patent Application No 2006907252 filed on 11 Dec. 2006 and 21 Dec. 2006, respectively, the contents of which are incorporated herein by reference.

### TECHNICAL FIELD

The present invention relates to outsourcing, and in particular relates to a system and method by which methodologies relating to outsourcing may be improved.

### BACKGROUND OF THE INVENTION

Outsourcing is the delegation of non-core operations or jobs from internal production within a business to an external entity that specializes in that operation. Outsourcing is a business decision that is often made to lower costs or focus on competencies. Offshoring involves transferring work to another country and may be an outsourcing transaction. Outsourcing can be defined as the process of transferring an existing business component, including the relevant physical and/or human assets, to an external provider in order to strategically use outside resources to perform activities previously handled in-house.

Outsourcing takes place when an organization transfers the ownership of a business process to a supplier. The key to this definition is the aspect of transfer of control. This differentiates outsourcing from business relationships in which the buyer retains control of the process or, in other words, tells the supplier how to do the work. In outsourcing, the buyer does not instruct the supplier how to perform its task but, instead, focuses on communicating what results it wants to buy; it leaves the process of accomplishing those results to the supplier. A central theme to outsourcing is that the client transfers the ownership of a business component such as a business process, function or technology to a third party, and thus transfers control of the “how” but retains control of the “what”. It is this transfer of ownership that characterizes outsourcing and often makes it a challenging and complex process.

Business processes are the procedures and rules a business entity must follow to meet its objectives. They specify the steps, tasks, and interactions thereof which are needed in order to achieve a goal, place constraints on activities, and identify resources needed between a service requester and a service provider. A business process may include services that are local to the business's domain, or span across enterprise boundaries. Interactions between two or more parties may be composed of simple message exchanges, or can involve long running interactions requiring detailed process management.

An outsourcing transaction is usually of a finite term, typically 5-10 years, and the client usually makes frequent payments in exchange for receiving the “what” over the term. At the end of term the client can re-establish the business component internally, outsource again to the same party, or outsource to another third party. A benefit of existing outsourcing arrangements is that the client obtains cost savings, possibly an improvement in service quality, and/or frees up client resources. Simply put, for the client it is a mechanism for enhancing operational profitability and for ultimately preserving capital. The provider obtains a long term contract that enhances its operating capabilities and value. The provider can in turn parlay this contract to further enhance its capabilities to improve their chances of obtaining additional contracts from new clients.

Outsourcing can thus be defined as a business transaction of transferring ownership in a business component (business process or function), in return for a reduction in costs of the service and an enhancement in service quality for a finite period. The transference is economically irrevocable in most cases.

Vendors rely predominantly on the benefits that specialization brings to create value in outsourcing. That is, they market the benefits of having economies of scale and a better know-how. Within the outsourcing industry each outsourcing provider strives to deliver a set of services efficiently through a strategy of aggregating outsourcing deals that are similar in nature. This aggregation strategy ostensibly allows providers to attain economies of scale which in turn would reduce the cost of delivering the service at a rate per unit as the provider's fixed costs can be absorbed across a larger set of deals.

However, economies of scale are rarely achieved by outsourcing vendors because of the sporadic sequence in which outsourcing deals are attained, the size of the addressable market, client reluctance to increase market power of vendors and the effort and resources required to secure an outsourcing contract. Many providers compete intensely for any one outsourcing deal and it is difficult for any one vendor to amass scale through winning similar outsourcing deals in a sequential manner within a meaningful timeframe. Also the timing of outsourcing deals is an independent event and beyond the control of any provider. Within an industry the timing of outsourcing deals that go to market may cause vendors to pursue and win outsourcing deals that cannot be aggregated to obtain meaningful efficiencies. These characteristics of the industry generally result in a pool of like outsourcing contracts being shared by a number of different providers, rather than being allocated to the most appropriate provider enabling effectiveness and efficiency.

Another impediment to outsourcing is that a company that proceeds with going to market to outsource part of its business incurs a search cost as part of the cost of outsourcing. This cost is repeated by many such organizations for similar outsourcing deals. Search costs can be in the vicinity of 1-2% of the total contract value of an outsourcing contract.

A further inefficiency in the existing outsourcing model is in the business development costs, being the cost of obtaining an outsourcing contract. This cost is normally borne by the provider and usually represents all costs associated with bidding for an outsourcing contract. The costs would typically involve costs such as responding to a RFI (Request for Information) or RFP (Request for Proposal), contracting costs, solution development costs, legal costs, due diligence costs, costs associated with participating in briefing sessions and costs of undertaking tours at facilities from which the services will be delivered. Typical business development costs are between 2% and 4% of a total contract value (TCV).

A common method for an outsourcing contract to be taken to market is to invite many providers to participate in the bidding process, which can be up to 8 or more providers for an outsourcing deal. In other words the industry as a whole incurs a business development cost which is the sum of all bidder business development costs for each outsourcing contract. In an example where there are 8 bidders all of whom spend 2% on business development, there would be a total business development cost of 16% of TCV.

Typically the industry norm for potential savings on an outsourcing deal is somewhere in the vicinity of 20% of the total contract value. Bearing this in mind the industry will expend, using the above example, 16% in business development costs to save the client 20%.

A company that proceeds to market to outsource a business component incurs an ongoing governance cost in respect of managing the contract and relationship with the successful provider. This cost is repeated by many such organizations for all outsourcing deals. Governance costs can be in the vicinity of up to 8% of the total contract value of an outsourcing deal.

Further, outsourcing deals are typically what is known as incomplete contracts. As such, a client organization which undertakes outsourcing may be subject to the risk of hold-up, in which the provider or vendor uses the terms within the contract to extract higher than reasonable commercial terms to undertake a new service or to alter the manner in which an existing service is provided. The problem of hold-up occurs predominantly because the client's power over the provider is diminished.

The savings that an organization obtains from outsourcing are reflected in the price it pays for the outsourced services over the term of the outsourcing deal, typically between 5-10 years. As this saving is not bankable upfront, there is a risk that it may never be realized.

Transformation is a term that describes a significant alteration of the manner in which a service is delivered to a client. For example if an outsourcing provider uses an accounting system to deliver finance and administration services, then where the accounting system has to be upgraded this constitutes transformation. Transformation requires investment, which ultimately is a cost that is borne by the party undertaking this transformation because of asset specificity. When multiple outsourcing providers providing services are required to undergo transformation, the costs of transformation are incurred by each individual provider.

Outsourcing agreements eventually terminate, and at this point the client organization will typically repeat the process of going to market for the next round of outsourcing agreement. This essentially repeats the establishment process and leads to the client and tendering vendors incurring the establishment costs discussed above all over again. The client can also incur further costs associated with transitioning the outsourcing agreement from a previous provider to a new provider.

Third party advisors (TPA) are consulting organizations that specialize in assisting organizations with the process of outsourcing. They typically receive their remuneration using a fee for service model, which is inherently based on selling billable hours. Such a model is not aligned with the outsourcing goals of the client. TPA rarely share in the success or failure of an outsourcing relationship or have the financial depth to be able to back their advice. Their interests are not sufficiently aligned with the interest of the client who is outsourcing, in that the client seeks a balance of risk and value. Upon renewal, the knowledge of the TPA originally used is often lost as the TPA used on the renewal may be a different organization.

Outsourcing engagements, whether new engagements or renewals, commonly rely on Third Party Advisors and or a competitive bid process as described above to determine the current market price for the services to be outsourced. This is not always readily determinable and is subject to the influences described above. This often results in providers either pricing their services too high and destroying potentiality, or pricing too low in a bid to win the business without providing service standards required and risks associated with the engagement.

Outsourcing agreements by their nature have material significance to a provider's profitability, and fluctuations in the revenue associated with such deals may expose the provider to adverse profit performance. As such, prudent outsourcing providers will incorporate additional contingency cost loadings to cater for such risk exposure for such outsourcing deals.

Current business models for outsourcing therefore do not maximize shareholder value for clients and involves considerable friction. Moreover, current outsourcing models are inherently risky for all parties, which has limited the market uptake of outsourcing.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF SUMMARY OF THE INVENTION

According to a first aspect the present invention provides a method of monetizing a cash flow asset obtainable from the difference between the costs of an in-house business component of a client and the costs of outsourcing that business component, the method comprising:

outsourcing the business component of the client to an outsourcing vendor; and

securitizing the asset.

According to a second aspect the present invention provides a system for outsourcing business components, the system comprising:

an input for receiving information defining a plurality of outsourcing concession business components; and

a processor for determining a pool allocation for each outsourcing concession business component based on the received information, the pool allocations being determined in a manner to increase potentiality, the processor further adapted to facilitate securitization of a cash flow asset derivable by outsourcing of each business component.

Thus, the present invention recognises that the cost savings of outsourcing may be thought of as a predictable but illiquid cash flow, and recognises that such an illiquid cash flow may be monetized by way of securitization.

Preferably, the outsourcing comprises:

a special purpose entity purchasing a plurality of business component concession options;

the special purpose entity pooling the business component concessions in a manner to improve outsourcing efficacy; and

the special purpose entity engaging an outsourcing provider to provide outsourcing services in respect of the or each pool of business components.

In preferred embodiments of the first aspect of the present invention, the securitization preferably involves issuing at least one type of financial instrument to finance the purchase of the or each business component. The financial instrument types preferably include at least one of:

a Class A instrument cross-collateralized against the expense stream of the client for the outsourcing of the business component; and

a Class B instrument comprising an equity interest in an entity controlling the outsourcing.

In preferred embodiments of the invention, the pool allocations are determined in a manner to reduce risk exposure of the pool. Additionally or alternatively, the pool allocations may be determined in a manner which increases credit standing of the or each pool.

According to a third aspect the present invention provides a Class A financial instrument cross-collateralized against an expense stream for outsourcing of the business component of a business.

According to a fourth aspect the present invention provides a Class B financial instrument comprising an equity interest in an entity controlling outsourcing of a pool of business components.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The present invention is directed to a system and method which will now be described with reference to the accompanying drawings, in which:

FIG. 1 is a system schematic which illustrates the manner in which outsourcing concession options are obtained in accordance with the business model of one embodiment of the present invention;

FIG. 2 is a schematic illustrating securitization of the special purpose entity created in the business model;

FIG. 3 illustrates temporal characteristics of an outsourcing pool formed in the business model;

FIG. 4 illustrates reduced volatility of an income stream of the pool; and

FIG. 5 illustrates a general-purpose computing device that may be used in an exemplary system for implementing the invention.

### DETAILED DESCRIPTION OF THE INVENTION

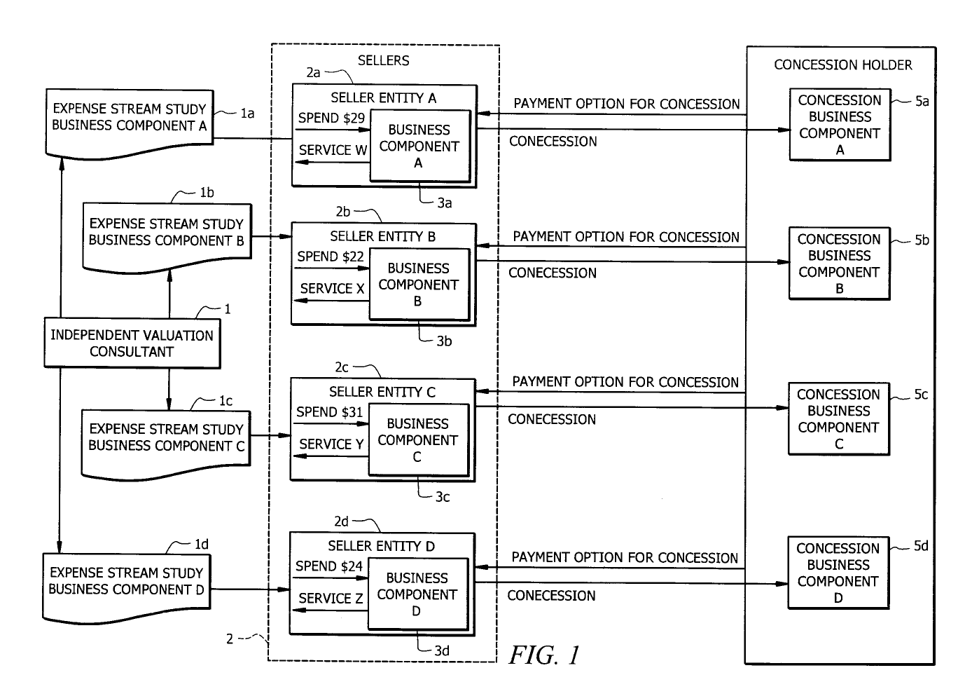

FIG. 1 illustrates the manner in which outsourcing concession options are obtained in accordance with the business model of one embodiment of the present invention. An option for a concession is purchased by a concession holder 4 using a concessions holding vehicle (CHV) from a company, seller 2, that seeks to securitize key operating expenses. For example human resources (HR) administration, IT costs, finance and administration expenses, marketing administration costs or the like may be the subject of such an option.

The option when exercised by the CHV provides for a concession with the exclusive right to securitize specific operating expenses which may require the underlying business component for that expense stream to be outsourced. In this embodiment of the present invention the option for a concession may, at the discretion of the CHV, not be exercised until an expense stream study is delivered to the CHV, or before 180 days of the option commencement whichever comes first. Should the option not be exercised by the CHV within a year, the option will lapse.

Once exercised, the resulting concession also has a first right of refusal for any outsourcing transactions that the company may enter into, which applies to all outsourcing whether currently active contracts that are to be renewed (but not extended) or any new outsourcing deal. In this embodiment of the present invention, the concession life is for a minimum period of 25 years and entitles the concession holder to securitize operating expenses for this period using a number of discrete SPV lock-in terms, for example 5 year terms.

In this embodiment a SPV lock-in term is a period for which an expense stream is securitized. At the end of this SPV lock-in term the securitized pool may be disaggregated and reconstituted into a new pool, and this process is particularly useful as it allows the value of securitization to be optimized if desired. During the life of a concession an expense stream may be disaggregated and reconstituted into many different pools but never more than one pool at any one point in time. The expense stream may be reconstituted within the same pool subject to certain conditions. A SPV lock-in term may be dissolved earlier than its term provided the early termination payout is adhered to.

The option for concession has a set of conditions on the CHV and the company that must be met for the concession to be granted. Inherent in the option is that if these conditions are met the seller 2 is obligated to proceed with the securitization process. Conditions set in the option for the concession for the CHV include a minimum potentiality to be attained (the target potentiality) on a stand-alone basis (SAP), company's cost of capital, list of approved and excluded vendors, service delivery quality, asset specificity requirements, terms and conditions relating to securitization, a notional expense study and an override target stand alone potentiality.

Stand alone potentiality is defined as the difference between the operating expense stream and the best possible saving that can be achieved by outsourcing the operating expense stream. Potentiality, or pooled potentiality, is defined as the difference between the operating expense stream and the committed repayment that can be achieved using the present securitization method. This is expressed in terms of a percentage. For example a potentiality of 20% on an expense stream of $20 m would mean that a $4 m repayment would be provided to the company through the securitization process. Potentiality is determined over the SPV lock-in period and uses the company's cost of capital, expense stream study and agreed baseline floor and ceiling. A spread is the difference between the stand alone potentiality and the pooled potentiality.

The expense stream study 1a, 1b, 1c, 1d is produced for each company 2a, 2b, 2c, 2d by a mutually agreed independent valuation consultant 1 using a methodology supplied by the CHV. The cost of preparing this study is borne by the company and it is owned by the company. In this embodiment of the present invention, it is a condition of the option for concession that the company undertake this study within 90 days of the commencement of the option period. Should the company fail to deliver a study within 180 days of the commencement of the option and prior to exercising the option, a notional expense stream study will be used in its place should the option be exercised. Where a notional expense stream study is used, an overriding of the target stand alone potentiality will also be used. The notional expense stream study is a pre-agreed set of parameters that may be used as the basis for securitization should the seller fail to deliver an expense stream study.

The independent valuation consultant undertakes an expense stream study 1a, 1b, 1c, 1d into the expense stream of each company 2a, 2b, 2c, 2d. Each such study essentially blue-prints the operating characteristics in terms of services, cost and service quality of the underlying business component(s) 3a, 3b, 3 c, 3d that contribute to the expense stream. This establishes a baseline profile for the respective business component. The study also projects the likely scenarios of the expense stream subject to key business drivers of the company. For example, if the expense stream is HR administration expense, the study will include all the underlying business processes, technology and people that are involved in delivering the services associated with this expense item. The expense stream study 1a, 1b, 1c, 1d is undertaken by a third party advisory firm (independent valuation consultant 1) using a defined methodology provided by the CHV.

Key information within the work-products delivered by the study are entered into a pooling system. This pooling system uses key information to determine the optimal pooling approach for multiple expense streams. It determines the SPV pools and the potentiality of each SPV pool.

An outsourcing vendor is asked to provide a firm bid for a pooled outsourcing agreement. The vendor commits to a cost of delivering the services required to all within the pool.

The option for a concession is purchased by the CHV for a fee which is negotiated with the company but is expressed as a percentage of the expense stream over a SPV lock-in period at a rate of potentiality. For example 25 basis points at 20% potentiality over 5 years for a total expense value (TEV) of $100 m would indicate a fee of $250K. The TEV is the sum of all operating expense streams for a period, being the SPV lock-in period. The price for an option may vary, for example it may be $1. It is to be appreciated that an option for a concession may be priced by any suitable method.

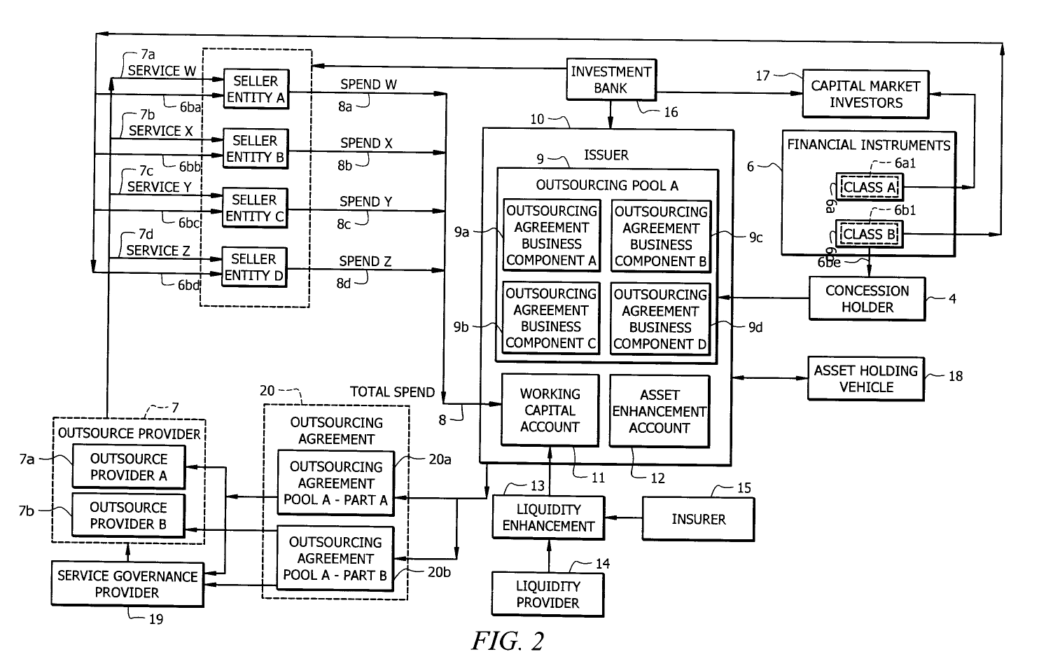

The payment by the CHV has to be made to the company for the option to commence. In this embodiment of the present invention, the CHV has up to 90 days to make this payment. The CHV must exercise the option to acquire the concession. The consideration or the exercise price for the option is that the seller may obtain cash or the Class A instruments 6a1 (discussed in the following with reference to FIG. 2) or a combination of both. The seller may in addition obtain Class B instruments 6b1 (discussed in the following with reference to FIG. 2). In this embodiment of the present invention, if the potentiality is 20% and the expense stream is $100 m over 5 years the cash or Class A instrument combination may be $20 m.

Further to the cash or Class A instruments the seller also may receive other financial instruments 6 in other tranches based on a distribution algorithm that will be defined within the option for concession agreement. In this embodiment of the present invention the value of the pool to be distributed in other tranches may be up to the value of the spread.

The expense stream study will declare a stand alone potentiality (SAP) valuation for an expense stream. The deemed hurdle potentiality will be the higher of either the target stand alone potentiality or the stand alone potentiality from the expense stream study. The deemed hurdle potentiality will be used as the basis for the CHV to exercise the option as discussed in the preceding.

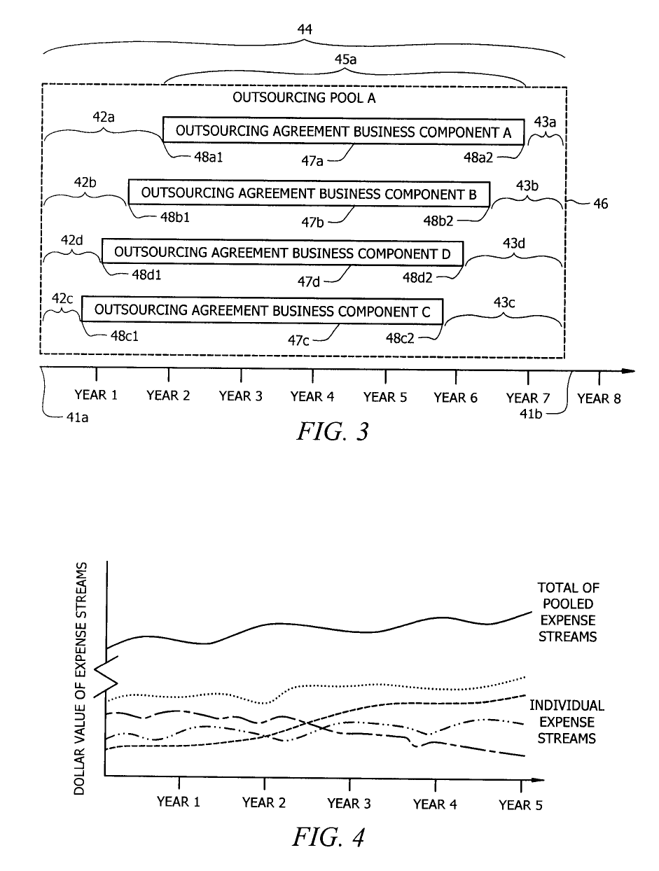

FIG. 3 illustrates temporal characteristics of an outsourcing pool formed in the business model of the present embodiment. Outsourcing pool 46, which is also illustrated in FIG. 2 as identified there by reference 9, may contain a plurality of outsourcing agreement business components 47a, 47b, 47c, 47d known as a pool. The pool commences at a time indicated by 41a and may cease operating at a time indicated by 41b.

Outsourcing agreement business components 47a, 47b, 47c, 47d may stagger in their respective go-live dates. The go-live date is when the outsourcing agreement business component 47a, 47b, 47c, 47d is deemed to commence quality service delivery. The go live date of 48a1, 48b1, 48c1, 48d1 is preceded by a transition period 42a,42b, 42c, 42d of each service to the outsourcing pool during which the outsourcing is established and ownership is transferred.

The outsourcing agreement business components 47a, 47b, 47c, 48d may also have staggered respective completion dates. The completion date is when the outsourcing agreement business component 47a, 47b, 47c, 48d is deemed to end quality service delivery. Completion date 48a2, 48b2, 48c2, 48d2 may be extended 43a, 43b, 43c, 43d to effect an aligned completion for the outsourcing pool 46 on the outsourcing pool completion date 41b.

The pooling system involves the independent valuation consultant 1 delivering to the concession holder 4 an expense stream study. Part of this process involves the entry of key information into a pooling system. The pooling system is used to determine the optimal pooling approach for multiple expense streams. It determines how the expense streams should be combined into SPV pools. It also determines how to allocate the outsourcing providers 7 to deliver services 7a, 7b, 7c, 7d required by a pool to sellers 2a, 2b, 2c, 2d. That is, for a particular pool there may be one or more outsourcing providers delivering the services for one Expense Stream.

The goal of the pooling system is to optimize the value of each SPV pool using a pooling algorithm. Considerations during the allocation process are increasing potentiality, reducing risk and enhancing the credit standing of a SPV pool. The SPV pool is geographically limited to a nominated geography. In this embodiment of the invention different combinations are also considered to provide for optimal transition timing 42a, 42b, 42c, 42d and extensions 43a, 43b, 43c, 43d subject to the terms and conditions associated with concession business component 5a, 5b, 5c, 5d respectively. In this embodiment the mix of expense streams is also optimized to minimize variability of the pooled expense streams.

It is important that the pooling mix be optimized in order to maximize potentiality. Potentiality is created by contracting out to one or more third party provider(s) the delivery of services required by the issuer through using a special purpose vehicle (SPV). The SPV has one SPV pool that is associated with it. A pool is associated to the securitization of one or more expense streams. Potentiality is achieved when the cost of services to the issuer is less than the total of the net expense streams flowing into the pool (SPV revenue). That is SPV revenues exceed total operating costs of the particular SPV pool (SPV operating expenses). This is determined over the life of the particular SPV (SPV term). Expenses for the ISSUER may includes costs including interest on the Class A securities, issuer administration fees, service delivery fees and governance fees.

The contracting out is an outsourcing arrangement between the company and a provider whereby the outsourcing arrangement 20 is governed and managed by a service governance provider 19 (SGP) on behalf of the issuer 10. The issuer 10 pays the SGP to manage this process. The SGP is responsible for authorizing payment to the provider. The issuer makes payments to outsourcing provider 7 accordingly.

Maximizing potentiality and minimizing risk are main goals of the pooling process. To achieve this, expense streams 8a, 8b, 8c, 8d of a plurality of sellers 2 are combined in differing combinations by the pooling system. The expense streams are covered by the option for a concession and have a corresponding expense study 1a, 1b, 1c, 1d. Each seller 2 can have a different quality profile for its services 7a, 7b, 7e, 7d even though the services are similar in nature. For example time to complete the processing of invoices may be different for each company in a pool.

To determine the cost of outsourcing the services to a provider, the pooling system uses a vendor specific module (VSM) provided by the provider that determines the cost of services at a specified grade of service. It also uses other parameters such as volume-metrics, transition timeframes and due-diligence.

Once the optimal pooling solution is determined the candidate vendor is approached by the CHV to provide a confirmed offer. This validates that the VSM quotation is within an acceptable range. The CHV will at some point request a best and final offer (BAFO) which obligates the vendor to take on the outsourcing using the standard outsourcing Terms & Conditions (T&C). Each vendor that is registered with concession holder 4 has to provide a vendor specific module (VSM). The VSM is a computerized system that embodies rules for quoting on outsourcing of defined business components. The interface to VSM is defined by concession holder 4 as well as the technological environment in which it will operate. Each vendor is bound to their quotation provided by their VSM when the quotation requested is in BAFO mode.

The nature of the concession entitlement is that the concession business component 5a, 5b, 5c, 5d enables the concession holder 4 to outsource all aspects relating to an expense stream, the scope of which may be defined by the expense study report. In essence the concession holder 4 can enter into an outsourcing arrangement between the issuer 10 and the outsourcing service provider 7 and the service governance provider 19. The issuer 10 has custodianship of the business components for the SPV lock-in term.

The concession business component 5a, 5b, 5c, 5d provides the right for the holder to undertake outsourcing arrangements on behalf of the seller in a discrete set of outsourcing arrangements that have a defined period of duration known as SPV lock-in term. In this embodiment of the present invention a concession may have a term that is fixed, for example 25 years, with a defined SPV lock-term of for example five years. In this example it affords the concession holder 4 the right to include the said expense stream into at least five distinct issues, each issue being of a maximum duration of five years in duration which in total equates to the example term of 25 years for the concession business component 5a, 5b, 5c, 5d.

Each issuer 10 has a distinct operating period fixed by the earliest commencement date of all pooled outsourcing agreement business components 9a, 9b, 9c, 9d and the latest completion date of all the pooled outsourcing agreement business components 9a, 9b, 9c, 9d. Within an issuer 10 the pooled outsourcing agreement business components 9a, 9b, 9c, 9d may differ in their respective SPV lock-in terms respectively.

As each outsourcing agreement business component 9a, 9b, 9c, 9d approaches its completion date, a process is activated to produce an expense stream study 1a, 1b, 1c, 1d using an independent valuation consultant 1. Such an expense stream study provides a revised stand alone potentiality (SAP) for the expense stream of seller 2a, 2b, 2c, 2d respectively, this revised SAP is used as the basis for incorporating the expense stream into a pool that may be within a different issuer or an issuer to be created.

An issuer 10 may have additional outsourcing agreement business components added to the outsourcing pool 9 after its commencement, subject to the terms and conditions of the particular issuer 10. Where this occurs it will adhere to the agreed terms and conditions (T&C) agreed to in the concession business component 5a, 5b, 5c, 5d. Once the last active outsourcing arrangement is completed the issuer 10 may continue to operate, may remain dormant or may be wound up. This depends on the terms and conditions defined within the concession business component 5a, 5b, 5c, 5d. Where it remains operational it will continue to distribute funds as defined in the issuer 10 article of incorporation or comparable instrument.

The underlying assets relating to the business components are in this embodiment owned by an asset holding vehicle 18 (AHV) that is a distinct entity to the issuer 10. Where this is the case the issuer shall have full ownership and control of the said entity that owns such assets. Where Class B financial instruments are issued by the issuer, calls of capital or new issues of capital may be undertaken to raise funds to enhance or replace said assets within the asset holding vehicle 18. Where new issues are required and existing shareholders do not participate the issuers may raise capital by diluting its interest in the asset holding vehicle 18. Funds raised as mentioned in the preceding are deposited within the asset enhancement account 12 and are to be used for such purposes.

The issuer may involve the services of an insurer 15, who may be associated with the investment bank 16 or the concession holder 4 to provide an insurance coverage in the event that one or more of the sellers 2a, 2b, 2c, 2d become insolvent or unable to meet its obligations according to the concession business component 5a, 5b, 5c, 5d respectively. In this event the insurance coverage will pay into the working capital account 11 the correct amount according to the insurance coverage policy agreement.

FIG. 2 illustrates securitization of the special purpose entity created in the business model of this embodiment of the invention. A multiple seller securitization can be used by organizations (particularly companies) to achieve a more efficient approach to receiving services from their business components that requires less capital and generates proceeds without relinquishing the required services. This novel approach can also be used by organizations to create a mechanism to fund ongoing capital demands to maintain and enhance the business component. In addition, embodiments of multiple seller securitizations provided herein minimize the burden of any one seller bearing the performance risks associated with all other seller participants in the securitization structure.

A plurality of sellers enter into agreement(s) with concession holder 4 to sell their interests in business components to an issuer 10. This is referred to as a concession 5a, 5b, 5c, 5d. The issuer 10 is structured as a bankruptcy-remote, special purpose entity (SPV) with respect to the activities of the plurality of seller. In some embodiments of the invention, the transaction involving the sale of business component portions 3A, 3B, 3C, 3D to the issuer 10 can be accounted as a “true sale” for legal and accounting purposes.

Preferably the sellers 2a, 2b, 2c, 2d cannot have call options on the business components or an automatic return of business components, for example. In addition, in certain aspects, the issuer 10 has the ability the sell the business components subject to certain restrictions. In addition, the securitization may be structured such that the business components of the issuer 10 are not substantively consolidated with any individual seller 2a, 2b, 2c, 2d, in the event of an insolvency of one or more of the sellers 2a, 2b, 2c, 2d, for example, for purposes of applicable insolvency law.

The securitization is structured such that no single seller 2a, 2b, 2c, 2d consolidates the issuer 10 for accounting purposes and, therefore, the debt issued by the issuer 10 and sold to the investors can be deemed “off balance sheet” for the sellers 2a, 2b, 2c, 2d.

The present embodiment further provides for the creation of financial instruments to provide an improved outsourcing business model. In this embodiment of the invention, the issuer 10 finances the purchase of the business component portions 3A, 3B, 3C, 3D through the issuance of a plurality of financial instruments 6 divided into at least two tranches (refer to 6a, 6b in FIG. 2). It can be appreciated that any suitable number of classes, tranches, and even subtranches associated with the plurality of financial instruments may be applied within the scope of the present invention.

In this embodiment the first tranche (6a) includes Class A financial instruments (also referred to as “Class A notes”) which can be considered senior financial instruments. The Class A instruments 6a1 may be considered cross-collateralized instruments backed by the outsourcing pool 10a held by the issuer 10. This cross-collateralization includes the expense streams commitment by the seller 2. In certain embodiments, the Class A instruments 6a1 may be rated (for example, “AAA” or investment grade).

In this embodiment, the Class A instruments 6a1 may be sold by the issuer 10 to an investment bank 16, who in turn may resell the Class A instruments 6a1 to one or more investors. Each seller 2a, 2b, 2c, 2d receives cash generated from the sale of the Class A instruments 6a1 to the investors. The generated cash is apportioned and distributed to the plurality of sellers in accordance with the business component portion 3A, 3B, 3C, 3D initially contributed to the issuer 10 by each seller 2a, 2b, 2c, 2d. For example, if seller 2a contributes 25% (in terms of fair market value as determined by the expense stream study 1a) of the total business components (valued using expense stream studies 1a, 1b, 1c, 1d) sold to the issuer 10, seller 2a should receive 25% of the cash generated by issuance and sale of the Class A instruments 6a1.

The second tranche (6b) may include Class B financial instruments 6b1 (sometimes referred to as “Class B preferred shares”) which can be considered subordinated financial instruments. The Class B instruments 6b1 may also be rated (for example, “B”, or “C”) or may be unrated that is non-investment grade. The Class B instruments 6b1 may comprise equity interests in the issuer 10, for example, or represent residual rights in the business components of the issuer 10.

In this embodiment, the Class B instruments 6b1 may be distributed to the plurality of sellers 2 and concession holder 4, or entities associated with the sellers 2 and concession holder 4. It can be seen that tranche 6b is associated with the outsourcing pool 10a of the issuer 10. Therefore, Class B instruments 6b1 are collateralized by, or represents a residual interest in, only the total business components sold to the issuer 10 by each seller.

In certain embodiments of the present invention, a liquidity enhancement facility 13 may be optionally associated with the issuer 10. In various aspects, the liquidity enhancement facility 13 provides funds to the extent that amounts on deposit in a working capital account associated with the issuer 10 are insufficient. The working capital generally comprises amounts received in respect of expense streams 8a, 8b, 8c, 8d on the business components held by the issuer 10. The issuer 10 may enter into a revolving liquidity enhancement facility 13 arrangement with a liquidity provider 14 that commits to advance funds to the issuer 10 for payment of certain priority amounts comprising, for example, accrued interest and commitment fees on the liquidity enhancement facility 13, interest on the Class A instruments 6a, and may involve administrative fees or servicing fees.

In certain aspects, the liquidity provider 14 is required to have a short-term rating and where the liquidity provider 14 fails to maintain the minimum required rating, it may be required to assign its rights and obligations to a replacement liquidity provider having the required rating. In other aspects, the liquidity 14 is not one of the sellers 2a, 2b, 2c, 2d and is not entitled to a direct or indirect right to reimbursement from any of the sellers 2a, 2b, 2c, 2d, but rather may only look to the collateral of the issuer 10 for payment. It is to be appreciated that use of a liquidity enhancement facility 13 may be necessary for the issuer 10 in view of the timing of cash flows associated with business components.

As described above, the issuer 10 issues a plurality of financial instruments that may be drawn upon to meet capital demands for business component asset enhancement. In various embodiments, and with particular regard to sellers the Class B instruments 6b may be purchased by an entity SPE associated with each seller 2a, 2b, 2c, 2d (respectively). The subsidiary may be bankruptcy-remote, wholly owned special purpose subsidiaries of each seller 2a, 2b, 2c, 2d. This is to avoid consolidation of the issuer 10 while providing a vehicle for the funding of capital calls.

The Class B instruments 6b1 may include a commitment of funds that may be drawn over time and therefore may have a funded balance and an unfunded commitment. In various aspects, the subsidiary established by the sellers 2a, 2b, 2c, 2d may purchase Class B instruments 6b1. The unfunded commitment on Class B instruments 6b1 may be used to enhance or maintain the assets held in the asset holding vehicle 18.

It can be seen that, in exchange for transferring the business components comprising the business component portions 3A, 3B, 3C, 3D to the issuer 10, the sellers 2a, 2b, 2c, 2d may receive cash and interests in investment grade instruments (for example, through the Class A instruments 6a) and below investment grade securities (for example, through the Class B instruments 6b1).

In this embodiment of the present invention, for the business component portions 3a, 3b, 3c, 3d sold, each seller 2a, 2b, 2c, 2d receives approximately the net proceeds of selling the Class A instrument 6a1 to the investors 17. This amount will equate to the deemed hurdle potentiality for sellers 2a, 2b, 2c, 2d respectively. The concession holder 4 may obtain Class A instrument 6a1 depending on the terms and conditions of the concession.

In another arrangement, the issuer 10 can grant a first-priority, perfected security interest in rights in the working capital and the outsourcing pool 10a to an indenture trustee for the benefit of note holders (i.e., holders of the Class A instruments 6a1) and the liquidity provider 14 of the liquidity enhancement facility 13. Also, due to the bankruptcy-remote nature of the issuer 10 and the non-recourse nature of the securitization debt, off-credit treatment of the securitization debt by rating agencies should be achievable.

In this embodiment of the invention, a financial entity such as the investment bank 16, for example, interacts with one or more of the plurality of sellers, the issuer 10, concession holder 4 and/or the investors. For example, the investment bank 16 may work with one of the sellers 2a, 2b, 2c, 2d to define various aspects of the structure and terms/conditions of the securitization including general collateral limitations.

Once the terms and conditions of the securitization are finalized, the investment bank 10 may offer the securitization as a financial product to one or more of the sellers 2a, 2b, 2c, 2d or other sellers. In addition, the issuer 10 may issue and sell the Class A instruments 6a1, for example, to the investors through the investment bank distribution network. The investment bank 16 may act as a placement agent or an initial purchaser for marketing and selling the Class A instruments 6a1 to third party investors. In various aspects, the investment bank may be instrumental in placing the liquidity enhancement facility 13 for the securitization. In other aspects, the investment bank may serve to evaluate and determine ratings for classes of the plurality of financial instruments issued by the issuer 10.

The multi-seller structure provided in accordance with the securitization embodiment of the present invention provides a range of benefits. With respect to liquidity, the sellers 2a, 2b, 2c, 2d are able to generate liquidity from the Class A instruments 6a1 sold to the investors and also retain upside on the business component portions 3A, 3B, 3C, 3D contributed to the issuer 10. With respect to capital impact, by retaining rated instruments, the sellers 2a, 2b, 2c, 2d may potentially improve their credit worthiness by paying down debt with proceeds raised through the securitization.

In addition, as discussed above, no individual seller 2a, 2b, 2c, 2d is likely to be exposed to the majority of the expected losses or expected residual returns on business components held by the issuer 10. Thus, no individual seller 2a, 2b, 2c, 2d should be considered a primary beneficiary of the issuer 10 for the purposes of consolidation. Further, it can be seen that, in certain aspects, business components may be removed from the balance sheet of the sellers 2a, 2b, 2c, 2d in exchange for a combination of cash, rated instruments, and/or unrated instruments.

The present invention therefore recognizes that outsourcing can be thought of as the permanent or quasi-permanent sale of an asset, the asset being a finite set of future cash flows related to a business component of a client. In return for the sale, consideration is obtained through the reduction in the cost of the services provided while having the service quality either enhanced or maintained. The present invention thus recognizes that outsourcing converts a series of cash flows into a benefit to the client and that, to date, organizations can be thought of as having used outsourcing as an indirect and inefficient method of financing. Based on this understanding, the present embodiment of the invention provides a business model to better serve this purpose.

The present invention further recognizes that a majority of outsourcing arrangements implemented to date are not based on value obtained from economics of scale, but rather are based on a better way of operating the business component, as a self-contained transaction. The present invention is based on the recognition that it is possible to create considerable value by aggregating complementary outsourcing deals and thereby expand the market for outsourcing.

Preferred embodiments of the present invention may thus provide for a new form of outsourcing for a plurality of sellers, utilising securitization to achieve a more efficient approach to receiving services from their business components. The method of preferred embodiments may require less capital and may generate proceeds without relinquishing the required services or incurring a loss of quality. Moreover, in preferred embodiments the method of the present invention can be used by organizations to create a mechanism to fund ongoing capital demands to maintain, enhance or replace the business component.

In preferred embodiments of the invention, there may be provided a new form of financial instrument for securitization of outsourcing cost savings. Such embodiments recognize that such cost savings are inherent in many types of operating expenses which can be outsourced. In preferred embodiments the financial instrument is supported by secured notes to create value in the operating expenses.

In preferred embodiments of the invention, the process of securitization involves, first, an entity (the originator) which desires financing identifying a payment stream comprising a predictable cash flow as an asset suitable for securitization. Second, a special legal entity or Special Purpose Vehicle (“SPV”) is created to which the originator sells the assets. This effectively separates the risk related to the original entity's operations from the risk associated with collection. When done properly the loans owned by the SPV are beyond the reach of creditors in the case of bankruptcy or other financial crisis of the originator; i.e. the SPV is bankruptcy remote.

In such preferred embodiments, to raise funds to purchase these assets the SPV then issues asset-backed securities to investors in the capital markets in a private placement or pursuant to a public offering. These securities are structured to provide maximum protection from anticipated losses using credit enhancements such as letters of credit, internal credit support, reserve accounts and the like. The securities are also reviewed by credit rating agencies that conduct extensive analyses of risk in the form of bad-debts experiences, cash flow certainties, and rates of default. Based upon such analyses, the agencies then rate the securities as a risk-discounted net present value, enabling their sale, usually in the form of mid-term notes with a typical term of three to ten years.

Finally, because the underlying assets in such embodiments are streams of future income, a pooling and servicing agreement establishes a servicing agent on behalf of the security holders. The services generally include: mailing monthly statements, collecting payments and remitting them to the investors, investor reporting, accounting, collecting on delinquent accounts, and conducting repossession and/or foreclosure proceedings as appropriate for the subject matter of the securitization. The originator, for a fee, typically services its own accounts because it already has the structures in place to do so.

The present invention thus exploits one or more of the numerous advantages of securitization. A principal advantage of securitization is in transforming relatively illiquid assets into liquid ones. In addition, as noted above, securitization insulates the holder of the securitized asset from the creditors and possible bankruptcy of the originator. Further, securitization is a means for an entity to access future incomes while transferring non-collection risk to others. It allows entities to raise money in capital markets at interest rates comparable to, or lower than, other generally available sources of funds. The limited-recourse nature of this financing is preferable to debt financing, which can involve personal guarantees of a borrower's principals. Securitized monies are not treated as debt so it is off-balance-sheet financing. This can favourably affect leverage and the debt to equity balance sheet ratio. Finally, securitization diversifies financing sources and allows companies to plan long-term projects and investments.

The computed difference between the original cash flow funding a business component and the cost for providing the service from the business component (the outsourcing fee) is a net cash flow. The present invention recognizes that this has capital market value when it is securitized.

The present invention thus liquefies expenses used to fund a business component. That is, the present invention takes a major stream of expense cash flows, detaches them from their original owner, and converts them into liquid assets using an inventive securitization model.

The present invention in preferred embodiments further provides for a new form of financial instrument for securitization of the potential cost savings inherent in operating expenses using outsourcing to generate the savings. The instrument is supported by secured notes that are separately and independently secured.

The invention in preferred embodiments enables a plurality of outsourcing deals to be aggregated prior to going to market. This enables an optimization of many outsourcing deals into a resultant pool(s). All this can be undertaken with minimal cost as it is undertaken using algorithms to determine the optimal combinations subject to certain constrains. Having a pooled set of outsourcing agreements which have been optimized creates value in the industry in two key ways (a) firstly a provider can eliminate the risk and uncertainty of associated with an aggregation strategy of acquiring a series of independent outsourcing deals which enables a provider to invest in delivery enhancement strategies, and (b) secondly the efficiencies obtained using a pooled outsourcing approach would reduce the cost per unit to deliver the service, this is estimated to be at least a 10% cost reduction.

This invention in preferred embodiments reduces the search costs for a pooled set of outsourcing deals as the deals are taken to market in aggregate form. For example, where there are five outsourcing deals that are pooled of a comparable size this could reduce the costs by up to a factor of five (being the number of deals being pooled).

The invention in preferred embodiments also has an aspect that requires providers to provide computerized algorithms in a predetermined format to enable search costs to be further reduced by using a technology enabled processes to determine the most appropriate provider.

The invention in preferred embodiments reduces the total business development costs for a pooled set of outsourcing deals in two aspects: (a) firstly only one vendor is invited to bid for a pooled set of outsourcing deals, this reduces the overall industry business development costs to that of the number invited; and (b) the quantum of business development costs is reduced to perhaps less than 1% of total contract value. The value created in this respect by the invention is significant not only for the outsourcing industry's BD costs, but also from the perspective of the saving passed onto the client.

This invention in preferred embodiments reduces the overall governance costs for a pooled set of outsourcing deals as the deals are managed using a common governance approach. In an example where there are five outsourcing deals that are pooled of a comparable size this could reduce the costs to as low as 3% of total contract value using economies of scope where the same asset is used to deliver governance services for many outsourcing relationships.

The invention in preferred embodiments increases power to the client in that the invention when implemented will have an aggregator who will issue many significant outsourcing deals, a vendor would need to reconsider whether to use a holdup strategy against such a powerful source of future business.

This invention in preferred embodiments tangibilizes value by returning to the organization the savings obtained using outsourcing, using a pooled approach, an upfront payment in cash or an equivalent through using a securitization mechanism. This provides the organizations with all the stated realized savings upfront. This payment upfront enables the organization to reduce liabilities, invest in higher yielding projects or improve its working capital.

This invention in preferred embodiments also provides the organization who undertakes the outsourcing additional upside benefits in sharing in any residual value that is created above and beyond the initial upfront payment.

This invention in preferred embodiments provides two particular benefits over the existing method (a) it provides a mechanism to raise capital from capital markets to fund transformation for a pool of outsourcing agreements (b) it reduces the overall costs of transformation for those companies within a pool. For example instead of transforming five outsourcing accounting systems in a pool, one system would be created that would be shared by all companies within a pool. This significantly reduces the investment to a individual company in a pool when compared to undertaking such a transformation on a stand-alone basis.

This invention in preferred embodiments reduces the costs, and disruption associated with renewals in that (a) transition is black-boxed from the client perspective, that is they are not disrupted by transition, (b) renewals and transition is handled by a specialist function of the invention that has considerable expertise in effecting the renewal, (c) the renewal process is undertaken using the embodiment of the invention as discussed above which further reduces the costs over the total life of outsourcing—which extends beyond the outsourcing arrangement.

This invention aligns the interest of the organization with balance or risk and value. The invention takes responsibility for undertaking the outsourcing process and being rewarded for creating value. The more value that is created the greater the reward for both client and vendor.

This invention in preferred embodiments further embodies two elements that address the problem of determining market value, namely the use of an independent consulting organization to execute a standardized study to determine the stand alone potentiality and a securitization method to realize potentiality and return it to the client. FIG. 4 illustrates a plurality of individual expense streams that would typically fluctuate over time, and illustrates how pooling results in less variability for the total expense stream. Outsourcing providers thus have less incentive to add contingency cost loadings to cater for risk of single contract arrangements. In risk management a bundle of assets exhibits greater financial strength than any single asset. This diversification principle provides a key benefit of pooling. It is also to be recognized that investors are more likely to invest in a security representing a share in a pool of such assets with much lower volatility and credit risk than a single asset security with widely variable returns.

The invention pools a plurality of expense streams 8a, 8b, 8c, 8d into outsourcing pool 9 as shown in FIG. 2 and through this pooling processes reduces the risk of adverse performance to a provider and therefore reduces contingencies a provider must incorporate into their respective bid. This invention reduces the cost and risk of outsourcing to outsourcing provider 7 whilst improving the quality of the outsourcing business being expressed as outsourcing agreement 20a, 20b to the outsourcing provider 7.

The present invention further recognises that considerable inefficiencies exist in the existing techniques of outsourcing, which necessitate that a significant potentiality must exist within any particular outsourcing opportunity so that parties receive sufficient value to warrant the risk and expense of undertaking an outsourcing arrangement. Typically the potentiality requirement using the existing art may be in excess of 45% to warrant a deal being consummated, more usually it is closer to a potentiality of 50%. This significant potentiality requirement in the existing art for outsourcing candidates therefore excludes a large number of expense streams that fall below such potentiality thresholds. By contrast, the present invention lowers the threshold of potentiality significantly, in some embodiments a potentiality as low as perhaps 25% would enable all counter-parties to receive sufficient value to warrant the risk and expense of undertaking an outsourcing arrangement. Therefore the present invention in preferred embodiments expands the total addressable market for outsourcing by lowering the potentially threshold required for an expense stream.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

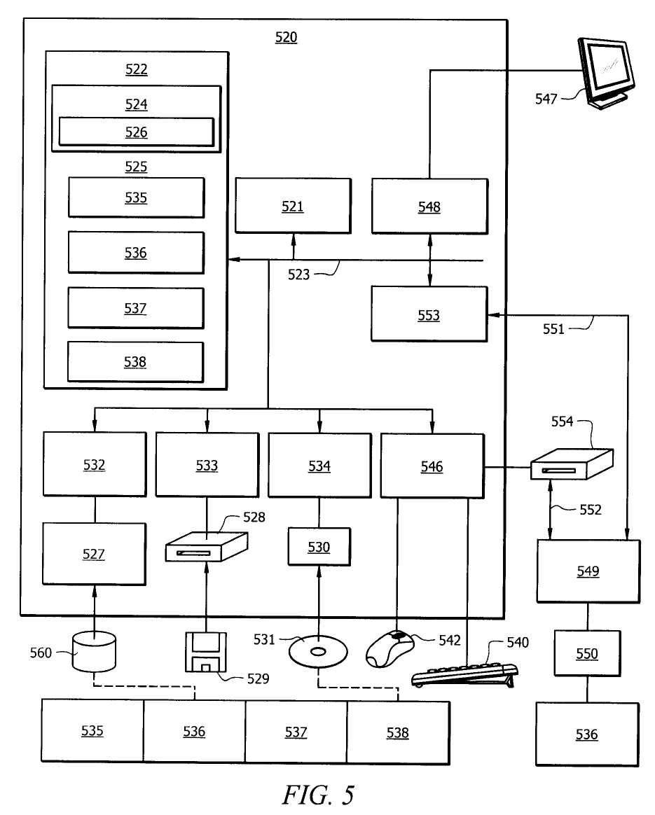

Turning to FIG. 5, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

In FIG. 5 a general purpose computing device is shown in the form of a conventional personal computer 520, including a processing unit 521, a system memory 522, and a system bus 523 that couples various system components including the system memory to the processing unit 521. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help to transfer information between elements within the personal computer 520, such as during start-up, is stored in ROM 524. The personal computer 520 further includes a hard disk drive 527 for reading from and writing to a hard disk 560, a magnetic disk drive 528 for reading from or writing to a removable magnetic disk 529, and an optical disk drive 530 for reading from or writing to a removable optical disk 531 such as a CD ROM or other optical media.

The hard disk drive 527, magnetic disk drive 528, and optical disk drive 530 are connected to the system bus 523 by a hard disk drive interface 532, a magnetic disk drive interface 533, and an optical disk drive interface 534, respectively. The drives and their associated computer-readable media provide nonvolatile storage of computer readable instructions, data structures, program modules and other data for the personal computer 520. Although the exemplary environment shown employs a hard disk 560, a removable magnetic disk 529, and a removable optical disk 531, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 560, magnetic disk 529, optical disk 531, ROM 524 or RAM 525, including an operating system 535, one or more applications programs 536, other program modules 537, and program data 538. A user may enter commands and information into the personal computer 520 through input devices such as a keyboard 540 and a pointing device 542. Other input devices (not shown) may include a microphone, joystick, game pad, satellite dish, scanner, or the like. These and other input devices are often connected to the processing unit 521 through a serial port interface 546 that is coupled to the system bus, but may be connected by other interfaces, such as a parallel port, game port or a universal serial bus (USB) or a network interface card. A monitor 547 or other type of display device is also connected to the system bus 523 via an interface, such as a video adapter 548. In addition to the monitor, personal computers typically include other peripheral output devices, not shown, such as speakers and printers.

The personal computer 520 may operate in a networked environment using logical connections to one or more remote computers, such as a remote computer 549. The remote computer 549 may be another personal computer, a server, a router, a network PC, a peer device or other common network node, and typically includes many or all of the elements described above relative to the personal computer 520, although only a memory storage device 550 has been illustrated. The logical connections depicted include a local area network (LAN) 551 and a wide area network (WAN) 552. Such networking environments are commonplace in offices, enterprise-wide computer networks, intranets and, inter alia, the Internet.

When used in a LAN networking environment, the personal computer 520 is connected to the local network 551 through a network interface or adapter 553. When used in a WAN networking environment, the personal computer 520 typically includes a modem 554 or other means for establishing communications over the WAN 552. The modem 554, which may be internal or external, is connected to the system bus 523 via the serial port interface 546. In a networked environment, program modules depicted relative to the personal computer 520, or portions thereof, may be stored in the remote memory storage device. It will be appreciated that the network connections shown are exemplary and other means of establishing a communications link between the computers may be used.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of monetizing a cash flow asset obtainable from the difference between the costs of an in-house business component of a client and the costs of outsourcing that business component, the method comprising:
outsourcing the business component of the client to an outsourcing vendor; and
securitizing the asset.

2. The method of claim 1 wherein the outsourcing comprises:
a special purpose entity purchasing a plurality of business component concession options;
the special purpose entity pooling the business component concessions in a manner to improve outsourcing efficacy; and
the special purpose entity engaging an outsourcing provider to provide outsourcing services in respect of the or each pool of business components.

3. The method of claim 1 wherein the securitizing involves issuing at least one type of financial instrument to finance the purchase of the or each business component.

4. The method of claim 3 wherein the financial instrument comprises a Class A instrument cross-collateralized against the expense stream of the client for the outsourcing of the business component.

5. The method of claim 3 wherein the financial instrument comprises a Class B instrument comprising an equity interest in an entity controlling the outsourcing.

6. The method of claim 1 wherein the pool allocations are determined in a manner to reduce risk exposure of the pool.

7. The method of claim 1 wherein the pool allocations are determined in a manner which increases credit standing of the or each pool.

8. A system for outsourcing business components, the system comprising:
an input for receiving information defining a plurality of outsourcing concession business components; and
a processor for determining a pool allocation for each outsourcing concession business component based on the received information, the pool allocations being determined in a manner to increase potentiality, the processor further adapted to facilitate securitization of a cash flow asset derivable by outsourcing of each business component.

9. The system of claim 8 further comprising:
a special purpose entity which purchases a plurality of business component concession options, pools the business component concessions in a manner to improve outsourcing efficacy; and engages an outsourcing provider to provide outsourcing services in respect of the or each pool of business components.

10. The system of claim 8 wherein the securitizing involves issuing at least one type of financial instrument to finance the purchase of the or each business component.

11. The system of claim 10 wherein the financial instrument comprises a Class A instrument cross-collateralized against the expense stream of the client for the outsourcing of the business component.

12. The system of claim 10 wherein the financial instrument comprises a Class B instrument comprising an equity interest in an entity controlling the outsourcing.

13. The system of claim 8 wherein the pool allocations are determined in a manner to reduce risk exposure of the pool.

14. The system of claim 8 wherein the pool allocations are determined in a manner which increases credit standing of the or each pool.

15. A Class A financial instrument cross-collateralized against an expense stream for outsourcing of the business component of a business.

16. A Class B financial instrument comprising an equity interest in an entity controlling outsourcing of a pool of business components.
